(19) United States
(12) Patent Application Publication
(10) Pub. No.: US 2019/0226554 A1
(43) Pub. Date: Jul. 25, 2019

(54) TIME ALTERING APPARATUS

(71) Applicants: Keir Finlow-Bates, Kangasala (FI); Jonathan Sean Callan, Cambridge (GB)

(72) Inventors: Keir Finlow-Bates, Kangasala (FI); Jonathan Sean Callan, Cambridge (GB)

(21) Appl. No.: 16/371,122

(22) Filed: Apr. 1, 2019

(51) Int. Cl. F16F 15/31; G04F 5/00

(52) U.S. Cl. CPC F16F 15/31; G04F 5/00

(57) ABSTRACT

Descriptions of time altering apparatuses for removing a need for leap seconds are provided. Currently leap seconds are applied to Universal Time Coordinated (UTC) in order to align UTC with mean solar time. In one embodiment a time measurement system is connected to a gigantic heavy flywheel positioned at at least one of a north rotational pole or south rotational pole of the Earth. The time measurement system may determine a shift of UTC away from mean solar time and may subsequently speed up or slow down the flywheel to adjust a rotational speed of the Earth in order to move UTC back to mean solar time. In a second embodiment a similar time measurement system may raise or lower heavy weights into mine shafts drilled at or near the equator of the Earth for a similar effect. Planetary speed adjustments may be written to a blockchain.

### TECHNICAL FIELD

This disclosure relates to time standards, and more specifically to time standards with associated leap seconds.

### BACKGROUND

A primary time standard by which clocks and time are regulated on Earth is Universal Time Coordinated (UTC). The UTC time standard uses a leap second, namely a one second adjustment, that is applied occasionally to UTC to keep time of day close to mean solar time.

A problem with leap seconds is that other time standards, such as Global Positioning System time (GPS time) and Temps Atomique International (TAI) do not use leap seconds. As a result, whenever UTC is adjusted with an application of a new leap second, software converting GPS time to UTC time must take the new leap second into account.

Leap second adjustment software is prone to error and companies producing satellite navigation system software expend significant test resources on ensuring no “bugs” are present. Errors in satellite navigation system software may have a significant negative impact on location dependent systems, and may even endanger human life.

A particular problem is that the Global Positioning System (GPS) as deployed and maintained by the United States of America uses GPS time, and the Global Navigation Satellite System (GLONASS) as deployed and maintained by the Russian Federation uses UTC time, and as a result satellite receivers using a combination of GPS and GLONASS satellite constellations must deal with leap seconds correctly in order to avoid position errors that may be hundreds of kilometers in magnitude.

It is therefore an intention of the present disclosure to address the problem of leap seconds through apparatuses capable of removing the need for leap seconds by adjusting UTC time.

### SUMMARY

In accordance with the present disclosure, an apparatus is provided for adjusting a rotational speed of a planet in response to detecting a drift away from mean stellar time of a time system, in order to counteract said drift and thereby remove a need for an application of a leap second to the time system.

In an embodiment, the apparatus for adjusting a rotational speed of a planet to counteract a need for an application of a leap second may comprise a time measurement system and a planetary rotational speed adjuster.

In the embodiment, the time measurement system may be configured to: determine a drifting of a time system away from mean stellar time; calculate an adjustment to a rotational speed of the planet to counteract the drifting; and apply the adjustment to the rotational speed of the planet through a use of the planetary rotational speed adjuster.

In some embodiments, the planetary rotational speed adjuster may comprise one or more gigantic heavy flywheels.

In some embodiments, the one or more gigantic heavy flywheels may be located near or at one or more of: a north rotational pole of the planet, and a south rotational pole of the planet.

In other embodiments, the planetary rotational speed adjuster may comprise: a very deep mine shaft, an extremely heavy weight, and a winch for lowering and raising said extremely heavy weight.

In the other embodiments, the very deep mine shaft may be located at or near an equator of the planet.

In a possible embodiment, the time system may comprise UTC, the planet may comprise the Earth, and mean stellar time may comprise mean solar time.

In other possible embodiments, the planet may comprise a planet other than the Earth and the time system may be a time system relevant to the planet other than the Earth.

In yet other possible embodiments, mean stellar time may be determined by a star other than the Sun.

In a further embodiment, the apparatus may comprise a blockchain, and adjustment parameters, as determined by the time measurement system and applied to the planet using the planetary rotational speed adjuster, may be written to the blockchain.

Those skilled in the art will further appreciate the remarkable advantages and superior features found in this disclosure together with other important aspects thereof on carefully reading the detailed description that follows in conjunction with the drawings.

### BRIEF DESCRIPTION OF THE DRAWINGS

The components in the figures are not necessarily to scale, emphasis instead being placed upon illustrating the principles of the present disclosure. In the figures, like reference numerals designate corresponding parts throughout the different views.

FIG. 1 is a diagram illustrating components of an embodiment of the present disclosure.

FIG. 2 is a diagram illustrating one possible embodiment of a planetary rotational speed adjuster.

FIG. 3 is a diagram illustrating another possible embodiment of a planetary rotational speed adjuster.

FIG. 4 is a flow chart illustrating a process for determining a drift in time and adjusting a planetary rotational speed accordingly.

### DETAILED DESCRIPTION

Various aspects of this disclosure are now described with reference to the drawings. In a description that follows, specific details are provided to promote a thorough understanding of one or more aspects of the disclosure.

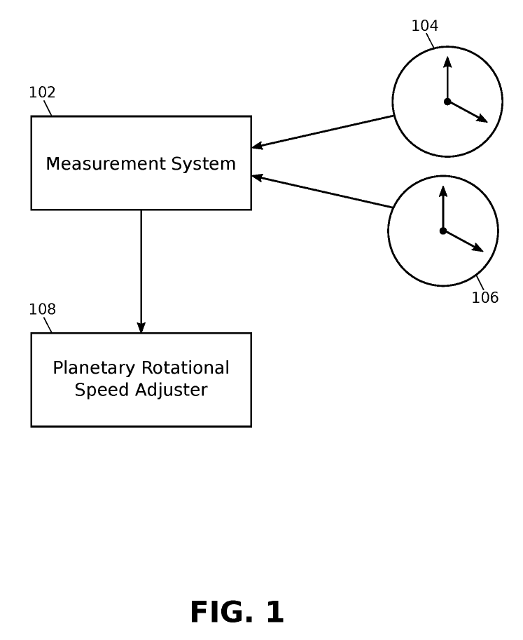

In FIG. 1 a diagram illustrating an apparatus comprising components of an embodiment of the present disclosure is presented.

The apparatus may comprise a time measurement system 102. The time measurement system may, on a regular basis, determine a difference between a time system 104 and a mean stellar time system 106, planetary diurnal time system, or some other time system.

The time measurement system 102 may record and store the difference, for example in a computer memory.

The time measurement system 102 may subsequently determine that a drift in the difference between the time system and the mean stellar time system has occurred.

If the drift is above a predetermined time interval, the time measurement system 102 may calculate a required change in a rotational speed of the planet in order to compensate for the drift.

The time measurement system 102 may then send a command to a planetary rotational speed adjuster 108 in order to adjust the rotational speed of the planet to counteract the drift between the time system 104 and the mean stellar time system 106.

The planetary rotational speed adjuster 108 may then undertake actions to adjust the rotational speed of the planet as required. Said actions are further illustrated below.

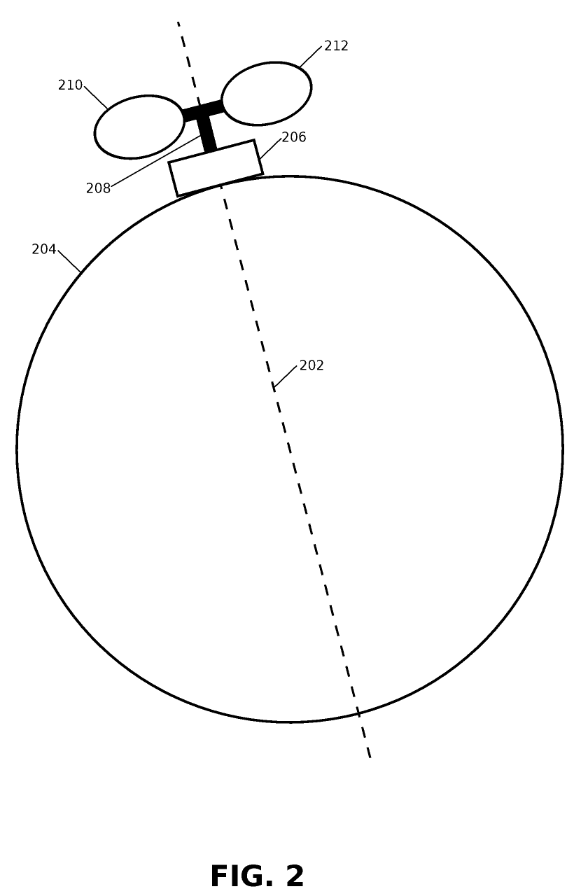

In FIG. 2 a diagram illustrating a possible embodiment of a planetary rotational speed adjuster is presented.

In the possible embodiment, a position of the planetary rotational speed adjuster on a planet 204 in relation to a planetary rotational axis 202 is shown.

In the possible embodiment, the planetary rotational speed adjuster may comprise: a motor 206, an axle 208, and a flywheel comprising one or more weights. In the possible embodiment two weights, 210 and 212, are shown. Those skilled in the art will appreciate that the flywheel may comprise a plurality of weights, or in some embodiments, a weighted disc or cylinder, or a weighted torus.

In the possible embodiment, the planetary rotational speed adjuster may increase a rotational speed of the planet by rotating in an opposite direction to a rotational direction of the planet. Similarly, the planetary rotational speed adjuster may decrease the rotational speed of the planet by rotating in a same direction as the rotational direction of the planet. Through this, the planetary rotational speed adjuster may adjust a difference between a time system and a mean stellar time system.

For example, denoting a mass of the Earth as Mₑ, and a radius of the Earth as Rₑ, those skilled in the art will readily compute that a moment of inertia Iₑ of the Earth is:

Iₑ=(2/5)MₑRₑ² [1]

If a moment of inertia of the planetary rotational speed adjuster is denoted by I_{w}, and the planetary rotational speed adjuster is approximated by a solid cylinder of mass M_{w} and radius R_{w}, then it may be be computed that the moment of inertia I_{w} is:

I_{w}=(1/2)M_{w}R_{w}² [2]

In other embodiments, the planetary rotational speed adjuster may be approximated by a torus.

As angular momentum in a closed system is conserved, by initially considering a system comprising the Earth and the planetary rotational speed adjuster, in which the planetary rotational speed adjuster is rotating at an angular velocity of ω_{w}, and the Earth is rotating at an angular velocity of ωₑ, if initially an angular velocity of the system is in stasis, then ωₑ and ω_{w} are equal, thus the planetary rotational speed adjuster appears stationary relative to the Earth, and as moments of inertia about a same axis may be added linearly, an initial angular momentum of the system Lᵢ may be defined by:

Lᵢ=(Iₑ+I_{w})ωₑ [3]

Expanding the system to include a Moon we find that over time, due to loss of energy through tidal action on the Earth, angular momentum may transfer out of the system to the Moon, hence increasing an orbital period of the Moon and altering a value of ωₑ.

In other situations, due to shifting of mass within a liquid core of the Earth, Iₑ may change.

Hence, due to either loss of angular momentum or conservation of angular momentum or a combination of both, ωₑ may change by a quantity, denoted below by δₑ.

Hence a new angular velocity ωₑ−δₑ may result in a change in a length of a day on the Earth. Even a small change in the length of the day on the Earth cumulatively results in a significant change in a time at which the Sun rises on a horizon of the Earth, resulting in a need for introducing the leap second to adjust UTC.

In either case, the new angular velocity ωₑ−δₑ may be compensated for by a change in the angular velocity of the planetary rotational speed adjuster from ω_{w} to ω_{w}+δ_{w} in order to return the new angular velocity ωₑ−δₑ to the angular velocity of ωₑ.

A value of δ_{w} may thus be calculated from [1], [2] and [3].

For a change in Iₑ, for example due to a change in mass distribution within the Earth, Lᵢ is constant, and thus to maintain constant ωₑ, a value of ω_{w} must be changed as follows:

Lᵢ=(I_{e+δ}ωₑ)+(I_{w}(ω_{w}+δ₂)) [4]

(Iₑ+I_{w})ωₑ=(I_{e+δ}ωₑ)+(I_{w}(ω_{w}+δ_{w})) [5]

Iₑωₑ+I_{w}ωₑ=I_{e+δ}ωₑ+I_{w}ω_{w}+I_{w}δ_{w} [6]

Iₑωₑ+I_{w}ωₑ=I_{e+δ}ωₑ+I_{w}ωₑ+I_{w}δ_{w} [7]

Iₑωₑ−I_{e+δ}ωₑ=I_{w}δ_{w} [8]

(Iₑωₑ−I_{e+δ}ωₑ)/I_{w}=δ_{w} [9]

A change in Iₑ to I_{e+δ} may be deduced from a change in ωₑ to ωₑ−δₑ, as follows:

I_{e+δ}(ωₑ−δₑ)=Iₑωₑ [10]

I_{e+δ}=Iₑωₑ/(ωₑ−δₑ) [11]

Hence by substitution of equation [11] into equation [9] it is possible to deduce an accurate value for δ_{w}, namely:

δ_{w}=(Iₑωₑ−(Iₑωₑ/(ωₑ−δₑ))ωₑ)/I_{w} [12]

A motor in the planetary rotational speed adjuster may thus be engaged to accelerate the velocity of the planetary rotational speed adjuster by a value computed in equation [12] in order to achieve a required counteraction to cancel the change in the rotational speed of the Earth and maintain UTC without an introduction of the leap second.

For a change in Lᵢ due to loss of angular momentum to external components such as the Moon, an associated change in the angular velocity of the Earth from ωₑ to ωₑ−δₑ may be observed, and similarly the angular velocity of the planetary rotational speed adjuster may change to ωₑ−δₑ. A new value Lⱼ may be calculated as follows:

Lⱼ=(Iₑ+I_{w})(ωₑ−δₑ) [13]

Lⱼ=Iₑωₑ+I_{w}ωₑ−Iₑδₑ−I_{w}δₑ [14]

In order to adjust the angular velocity of the Earth back to ωₑ it may be necessary to adjust the angular velocity of the planetary rotational speed adjuster relative to the Earth with, for example, a motor. Thus, Lⱼ remains constant, but the angular velocity of the Earth is returned to ωₑ by the angular velocity of the planetary rotational speed adjuster changing to ωₑ−δₑ+δ_{w}. Therefore:

Lⱼ=Iₑωₑ+I_{w}(ωₑ−δₑ+δ_{w}) [15]

Substituting equation [14] into equation [15] allows a solution for δ_{w} using only known quantities:

Iₑωₑ+I_{w}ωₑ−Iₑδₑ−I_{w}δₑ=Iₑωₑ+I_{w}(ωₑ−δₑ+δ_{w}) [16]

−Iₑδₑ=I_{w}δ_{w} [17]

δ_{w}=−(Iₑ/I_{w})δₑ [18]

Again, a motor in the planetary rotational speed adjuster may thus be engaged to accelerate the velocity of the planetary rotational speed adjuster by a value computed in equation [18] in order to achieve a required counteraction to cancel the change in the rotational speed of the Earth and maintain UTC without an introduction of the leap second.

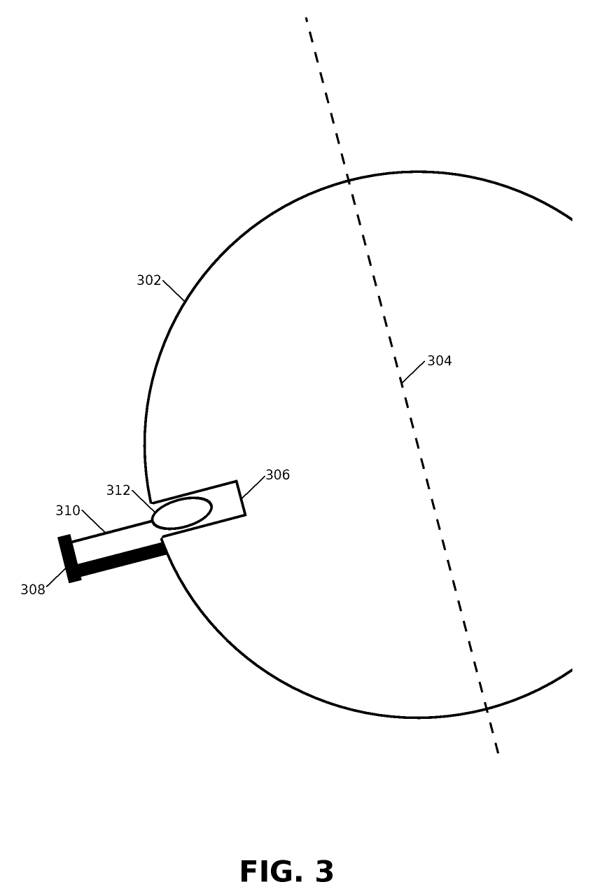

In FIG. 3 a diagram illustrating an alternate embodiment of a planetary rotational speed adjuster is presented.

In the alternate embodiment, a position of the planetary rotational speed adjuster on a planet 302 in relation to a planetary rotational axis 304 is shown. Those skilled in the art will appreciate that the position is optimal when on or close to an equator of the planet.

In the alternate embodiment, the planetary rotational speed adjuster may comprise: a very deep mine shaft 306, a winch 308, a cable 310 and an extremely heavy weight 312. In some embodiments the extremely heavy weight 312 may comprise a large quantity of depleted uranium or other dense substance.

In some embodiments the winch and the cable may be replaced by a threaded shaft and fixed threaded bolt. In some other embodiments the winch and the cable may be replaced by one or more toothed rails and one or more cogs.

In the alternate embodiment, the planetary rotational speed adjuster may increase a rotational speed of the planet by lowering the extremely heavy weight 312 deeper into the very deep mine shaft 306. Similarly, the planetary rotational speed adjuster may decrease the rotational speed of the planet by raising the extremely heavy weight 312 away from a base or bottom of the very deep mine shaft 306. Through this, the planetary rotational speed adjuster may adjust a difference between a time system and a mean stellar time system.

If a moment of inertia of the planetary rotational speed adjuster is denoted by Iᵥ, and the planetary rotational speed adjuster is approximated by a point-like mass Mᵥ a distance Rᵥ from an axis of rotation of the Earth then it may be be computed that the moment of inertia Iᵥ is:

Iᵥ=MᵥRᵥ² [19]

The moment of inertia of the Earth may computed, as before, using equation [1].

Remembering that angular momentum in a closed system is conserved, by initially considering a system comprising the Earth and the alternate embodiment of the planetary rotational speed adjuster, to those skilled in the art it is clear that the alternate embodiment of the planetary rotational speed adjuster will always rotate at a same velocity as the Earth, which may initially be denoted by ω, and as moments of inertia about a same axis may be added linearly, an initial angular momentum of the system Lᵢ may be defined by:

Lᵢ=(Iₑ+Iᵥ)ω [20]

Considering a case in which the angular momentum of the Earth and hence the angular velocity of the Earth change, for example due to loss of angular momentum to external components such as the Moon, a new equation for the system may comprise:

Lⱼ=(Iₑ+Iᵥ)(ω−δₑ) [21]

In order to adjust the angular velocity of the Earth back to ωₑ it may be necessary to raise or lower the alternate embodiment of the planetary rotational speed adjuster, adjusting the moment of inertia Iᵥ to I_{δ} and hence altering the angular velocity of the system. As Lⱼ remains constant during this adjustment, we may write:

(Iₑ+Iᵥ)(ω−δₑ)=Iₑω+I_{δ}ω [22]

Iᵥ(ω−δₑ)−Iₑδₑ=I_{δ}ω [23]

The new moment of inertia I_{δ} required may be calculated from a new radius of orbit of the alternate embodiment of the planetary rotational speed adjuster:

I_{δ}=Mᵥ(Rᵥ−R_{δ})² [24]

Substituting equation [19] and equation [24] into equation [23] results in:

MᵥRᵥ²ω−MᵥRᵥ²δₑ−Iₑδₑ=Mᵥ(Rᵥ−R_{δ})²ω [24]

0=MᵥωR_{δ}²+2MᵥRᵥωR_{δ}−(MᵥRᵥ²δₑ+Iₑδₑ) [25]

As those skilled in the art will understand, there are two solutions for R_{δ}: a first solution involving a relatively small change, and a second solution involving a large change through the axis of rotation and to an antipodal position corresponding to the first solution. Hence R_{δ} may be determined by solving a quadratic equation [25] in R_{δ} and selecting the first solution. Hence:

R_{δ}=−2MᵥRᵥω±√(2(Mᵥ²Rᵥ²ω²−Mᵥω(MᵥRᵥ²δₑ+Iₑδₑ))/Mᵥω) [26]

As all elements on a right hand side of equation [26] are known, the winch or the one or more toothed rails and one or more cogs in the alternate embodiment of the planetary rotational speed adjuster may thus be engaged to lower or raise the extremely heavy weight by a value for R_{δ} computed in equation [26] in order to achieve a required counteraction to cancel the change in the rotational speed of the Earth and maintain UTC without an introduction of the leap second.

Considering a case in which the moment of inertia of the Earth changes from Iₑ to I_{E}, and hence the angular velocity of the Earth change, for example due to shifting of masses of different density within the Earth, a new equation for the system in which the angular momentum remains constant may comprise:

Lᵢ=(I_{E}+Iᵥ)(ω−δₑ) [27]

In equation [27] the angular velocity of the Earth has changed by δₑ, as the moment of inertia of the Earth has changed to I_{δ}. Substituting equation [3] into equation [27] we obtain:

(Iₑ+Iᵥ)ω=(I_{E}+Iᵥ)(ω−δₑ) [28]

Iₑω=I_{E}ω−I_{E}δₑ−Iᵥδₑ [29]

In order to adjust the angular velocity of the Earth back to ω it may be necessary to raise or lower the alternate embodiment of the planetary rotational speed adjuster, adjusting the moment of inertia Iᵥ to I_{δ} and hence altering the angular velocity of the system. As Lᵢ remains constant during this process, we may write:

(I_{E}+Iᵥ)(ω−δₑ)=I_{E}ω+I_{δω} [30]

Iᵥ(ω−δₑ)−I_{E}δₑ=I_{δ}ω [31]

The new moment of inertia I_{δ} required may be calculated from a new radius of orbit of the alternate embodiment of the planetary rotational speed adjuster:

I_{δ}=Mᵥ(Rᵥ−R_{δ})² [32]

Substituting equation [19] and equation [32] into equation [31] results in:

MᵥRᵥ²(ω−δₑ)−I_{E}δₑ=Mᵥ(Rᵥ−R_{δ})²ω [33]

Solving [33] results in two solutions from a quadratic equation, as shown in [34]:

R_{δ}=−2MᵥRᵥω±√(2(Mᵥ²Rᵥ²ω²−Mᵥω(MᵥRᵥ²δₑ+I_{E}δₑ))/Mᵥω) [34]

Equation [34] is similar in format to equation [26], and again a smaller of two possible values for may be selected for R_{δ} as a change in position of the new radius of orbit of the alternate embodiment of the planetary rotational speed adjuster.

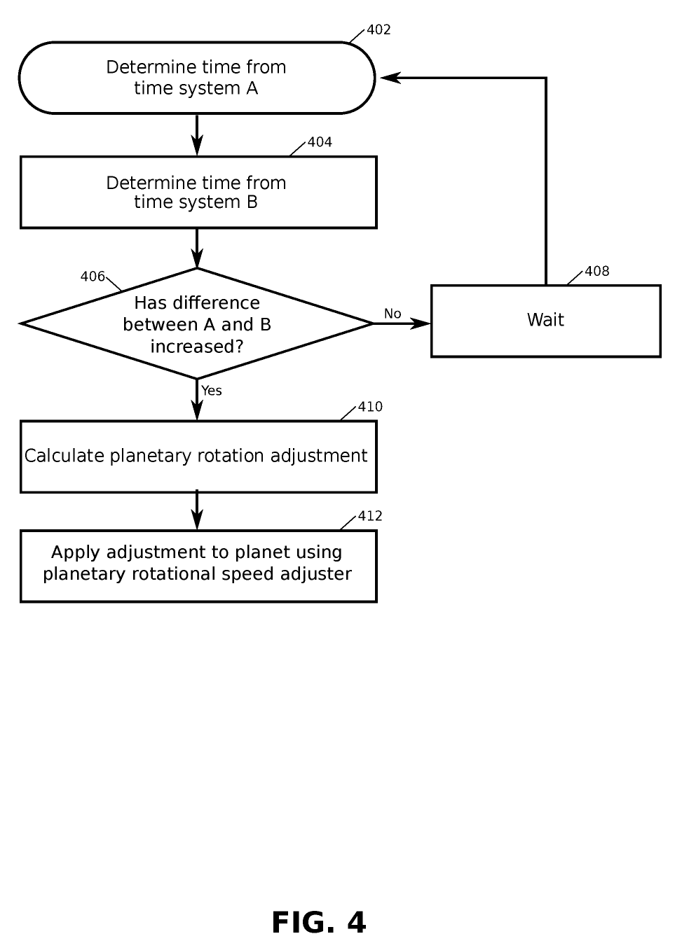

We proceed now to FIG. 4, in which a flow chart illustrating a process for determining a drift in time and adjusting a planetary rotational speed accordingly, in an embodiment of the present disclosure, is presented.

The process may be implemented within the time measurement system disclosed in an earlier section of the present disclosure.

In the embodiment operations may commence with the time measurement system determining time from a time system A, as shown in step 402. In some embodiments, time system A may comprise mean stellar time.

In the embodiment, operations may proceed with the time measurement system determining time from a time system B, as shown in step 404. In some embodiments, time system B may comprise UTC.

In the embodiment, operations may continue by the time measurement system examining if a difference between time system A and time system B has increased, as shown in step 406. If the time measurement system determines that the difference has not increased above a predetermined threshold, operations may proceed to step 408, and the time measurement system may wait a predetermined time before returning to step 402 of the process.

In the embodiment, if the time measurement system determines that the difference has increased above a predetermined threshold, operations may proceed to step 401, in which the time measurement system may calculate an adjustment required to a planetary rotation speed in order to reduce the difference.

In the embodiment, operations may proceed to step 412, in which the time measurement system may transmit a command to the planetary rotational speed adjuster to adjust planetary rotational speed in order to reduce the difference below the threshold.

In some embodiments, operations may then return to step 402, in a potentially never-ending cycle of time system comparison and planetary rotation speed adjustment.

The foregoing description details certain embodiments of the apparatuses disclosed herein. It will be appreciated, however, that no matter how detailed the foregoing appears in text, the apparatuses can be implemented in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged, duplicated or excluded from other embodiments.

It will also be appreciated by those skilled in the art that apparatuses and methods disclosed herein may be deployed on the Earth, or on other planets, moons, asteroids and satellites within the solar system, and indeed on other orbiting bodies within other stellar systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting.

As will be appreciated from the above discussion, an advantage of the apparatus of this disclosure includes adjusting the rotational speed of the Earth or other planet or orbiting system in space in order to remove the need for leap seconds in a time system.

What is claimed is:

1. An apparatus for adjusting a rotational speed of a planet to counteract a need for an application of a leap second, comprising a time measurement system and a planetary rotational speed adjuster, the time measurement system configured to:
determine a drifting of a time system away from mean stellar time;
calculate an adjustment to a rotational speed of the planet to counteract the drifting; and
apply the adjustment to the rotational speed of the planet through a use of the planetary rotational speed adjuster.

2. The apparatus of claim 1, wherein the planetary rotational speed adjuster comprises one or more gigantic heavy flywheels.

3. The apparatus of claim 2, wherein the one or more gigantic heavy flywheels are located near or at one or more of: a north rotational pole of the planet, and a south rotational pole of the planet.

4. The apparatus of claim 1, wherein the planetary rotational speed adjuster comprises a very deep mine shaft, an extremely heavy weight, and a winch for lowering and raising said extremely heavy weight.

5. The apparatus of claim 4, wherein the very deep mine shaft is located at or near an equator of the planet.

6. The apparatus of claim 1, wherein the time system comprises Universal Time Coordinated, the planet comprises the Earth, and mean stellar time comprises mean solar time.

7. The apparatus of claim 1, wherein the apparatus comprises a blockchain, and adjustment parameters as determined by the time measurement system and applied to the planet using the planetary rotational speed adjuster, are written to the blockchain.
